(19) United States
(12) Patent Application Publication
(10) Pub. No.: US 2026/0154891 A1
(43) Pub. Date: Jun. 4, 2026

(54) Personalized AI-Driven Real-Time Avatar Integration and Autonomous Media Generation System with Secure Biometric Authentication

(71) Applicant: Dean Bowes, Mableton, GA (US)

(72) Inventor: Dean Bowes, Mableton, GA (US)

(21) Appl. No.: 19/458,919

(22) Filed: Jan. 25, 2026

(51) Int. Cl. G06T 13/40; G06F 21/32; H04L 9/32

(52) U.S. Cl. CPC G06T 13/40; G06F 21/32; H04L 9/3218

(57) ABSTRACT

The present invention provides a unified AI-driven media ecosystem enabling users to seamlessly integrate personal avatars into pre-recorded visual or audio media and generate fully autonomous content. The system supports adult personalization, supervised child engagement, and AI-generated open-ended narratives. User avatars are mapped in real time onto original media stored in a proprietary .AIMovie or .AIMusic file format, preserving unaltered audiovisual or audio-only content. Biometric authentication, including FaceID, ensures authorized access, while blockchain and zero-knowledge proofs enforce secure validation without bypassing consent. The system dynamically adapts narratives, synchronizes expressions, lip movements, and gestures, or user vocal characteristics, and allows collaborative input. By combining real-time avatar integration, AI-driven content creation, and advanced security measures, the invention transforms traditional media consumption into an immersive, interactive, and ethically governed experience for children and adults alike.

### TECHNICAL FIELD

The present invention relates to digital content creation, AI-assisted media personalization, and autonomous cinematic systems. More specifically, it concerns real-time avatar integration into pre-recorded media, child-supervised avatar playback, and AI-driven open-ended media generation, employing biometric authentication, blockchain, and zero-knowledge proof validation to ensure secure, consent-driven interaction.

### BACKGROUND AND PROBLEM STATEMENT

Traditional media consumption is static and limited, providing viewers with pre-recorded films, television shows, or interactive content without personalization. While face-swapping and avatar integration technologies exist, they typically require specialized post-production workflows, are limited in scope, or fail to ensure secure, authorized access. Current systems lack:
1 Real-Time Personalization: Average consumers cannot effortlessly integrate themselves into professional media without technical expertise.
2 Child Supervision: Existing technologies do not provide parental control mechanisms when avatars involve minors.
3 Autonomous AI Content Generation: There is no commercially available system that creates fully autonomous, open-ended cinematic experiences tailored to user input.
4 Security and Validation: Most platforms fail to combine biometric authentication, blockchain, and zero-knowledge proofs to protect content, avatars, and user identity.

The present invention addresses these deficiencies by providing a modular, secure, and immersive media ecosystem.

### SUMMARY OF THE INVENTION

The present invention provides a unified system enabling real-time, personalized avatar integration and AI-driven autonomous media generation across multiple devices. The system includes three core components:
1 Adult Avatar Personalization: Users create digital avatars on a mobile device, which are mapped in real time onto original media contained in the proprietary .AIMovie file format. Facial expressions, lip movements, and gestures are synchronized for seamless integration. Biometric authentication (FaceID) validates user identity before playback.
2 Child Time Supervised Playback: Child avatars are integrated into media under the governance of a parent or guardian. Parental biometric verification is mandatory for content access, ensuring consent-driven, secure child engagement.
3 AI Autonomous Movie Generation: The system generates fully autonomous cinematic experiences using AI-driven narrative, character, and scene creation. Content is dynamic and open-ended, adapting continuously to user input while maintaining ethical safeguards.

Blockchain and zero-knowledge proof layers validate avatar access and content integrity without bypassing FaceID. Together, these components provide a secure, immersive, and interactive media ecosystem for both children and adults.

### DETAILED DESCRIPTION OF THE INVENTION

### 1. System Architecture

The invention is implemented across multiple devices, including smartphones, tablets, smart TVs, and desktop systems. The system architecture consists of:

### A. Personalized Avatar Integration Module

Avatar Capture and Storage: Users scan their faces using mobile cameras or dedicated devices. Scanned avatars are stored securely within the .AIMovie file format, preserving original content without alteration.
Real-Time Mapping: AI-driven facial recognition, deep learning, and motion tracking synchronize user avatars with actors' expressions, lip movements, and gestures during playback.
Security Enforcement: FaceID biometric authentication is required before playback. Blockchain and ZKP validate user identity and content access while preserving privacy.

### B. ChildTime Supervised Module

Parental Control: Child avatars are playable only under the supervision of an authorized parent or guardian.
Mandatory Verification: Parent biometric authentication is enforced before any child avatar playback.
Secure Avatar Mapping: The system maps child avatars into pre-recorded content (.AIMovie), maintaining fidelity and safety in accordance with consent protocols.

### C. AI Autonomous Movie Generation Module

Dynamic Narrative Engine: Users provide prompts (e.g., “Beach in Miami with toes in sand”), and AI generates unique characters, scenes, and storylines.
Open-Ended Content: Narratives evolve continuously without fixed beginnings or endings.
Ethical Safeguards: Content moderation filters prevent creation of harmful, offensive, or illegal material while preserving creative freedom.
Collaborative Mode: Multiple users can contribute prompts and guide the AI-generated narrative simultaneously.

### 2. Communication and Integration

Device Synchronization: User avatars and AI-generated content are synchronized across devices while preserving security and integrity.
Playback Interfaces: Supports smart TVs, VR/AR headsets, gaming consoles, and mobile devices.
Content Format: Original media is stored within .AIMovie, enabling real-time avatar replacement without modifying the original audiovisual files.

### 3. Security and Privacy Features

Biometric Authentication: FaceID or equivalent biometrics enforce user authorization; cannot be bypassed.
Blockchain Validation: Stores access and authorization logs in tamper-resistant records.
Zero-Knowledge Proofs: Verify access rights without revealing sensitive biometric or content information.
Encrypted Storage: Avatars and AI-generated content are encrypted, preventing unauthorized access or modification.

### 4. Operational Workflow

1 User scans avatar(s) via authorized device.
2 Biometric verification (FaceID) confirms identity.
3 Avatar is mapped onto original media in real time (.AIMovie).
4 For children, parent biometric verification is enforced.
5 AI-generated content is created per user input or prompt.
6 Blockchain and ZKP validate access and ensure integrity.
7 Personalized or AI-generated media is delivered for interactive playback.

### Advantages of the Invention

1 Mandatory Biometric Security: Ensures that only authorized users can access and manipulate content, and enforces parental supervision for children. FaceID is never bypassed, protecting both privacy and security.
2 Original Content Preservation: The .AIMovie file format stores the original media (e.g., movies, TV episodes) without alteration, maintaining fidelity and enabling safe real-time avatar integration.
3 Comprehensive Ecosystem Control: By combining adult avatars, child-supervised avatars, and autonomous AI movie generation, the system provides a unified and extensible entertainment platform.
4 Tamper-Resistant Validation: Blockchain and zero-knowledge proofs enforce content authorization and access records without exposing personal or biometric data.
5 Open-Ended, AI-Driven Narratives: Autonomous AI-generated media continuously evolves based on user prompts, allowing immersive and creative experiences without predefined beginnings or endings.
6 Collaborative Media Experiences: Multiple users can co-author AI-generated content in real time, enabling shared and interactive storytelling.
7 Cross-Platform Compatibility: Works with televisions, mobile devices, virtual reality systems, and gaming consoles, ensuring broad accessibility and immersive playback.
8 Ethical Content Enforcement: AI governance safeguards prevent the creation of harmful, illegal, or unsafe content while maintaining user creative freedom.
9 Seamless Real-Time Integration: Facial expressions, lip movements, and gestures of user avatars are synchronized with the original media for natural and realistic personalization.
10 Cost Efficiency: Consolidates multiple inventions (Adult Avatar, Child Time, AI Autonomous Movie Generation) into a single patent, reducing filing and maintenance costs while protecting the full ecosystem.

### Conclusion

The present invention provides a comprehensive AI-driven media system that enables real-time personalization, secure biometric verification, and autonomous content generation. By integrating adult avatars, child-supervised avatars, and AI-generated open-ended narratives within the .AIMovie file format, the system preserves original content while providing immersive, interactive, and ethically governed experiences. Blockchain and zero-knowledge proofs ensure tamper-resistant validation, while mandatory FaceID guarantees security and parental oversight. The invention unifies the full ecosystem of personalized media into a single platform, delivering creative freedom, cross-device compatibility, and a safe environment for users of all ages. This transformative approach bridges traditional media limitations with a dynamic, user-centric, and fully controlled entertainment experience.

Addendum: The .AIMovie File Format and Processing Workflow

The present invention employs a proprietary file format, .aiMovie, which stores both the original audiovisual content and metadata necessary for real-time personalized avatar integration and autonomous AI-driven content generation. The .aiMovie format is a core component of the system, enabling secure, immersive, and interactive media experiences across multiple devices, including Apple TV, while preserving original content integrity.

### Workflow Overview

1 Movie Loading in Jupyter Notebook
   The user opens the original movie, such as Charlie Chaplin: The Kid, within a Jupyter Notebook environment.
   This environment allows frame-by-frame playback and real-time annotation.
2 Actor Image Selection
   Known source images of the target actor can be selected by the user (up to 20 images).
   These images form the basis for training a personalized facial recognition and mapping model.
3 Bounding Box Annotation
   As the movie plays in the notebook, a bounding box interface allows the user to define actor face regions in individual frames.
   Clicks generate bounding boxes, and their coordinates are captured and stored in the backend for processing.
4 Training the Model
   Selected images from step 2 and bounding box coordinates from step 3 are used to train the facial recognition and tracking model.
   The model learns to track actor facial movement, expressions, and orientation.
5 Facial Tracking Metadata Storage
   Facial tracking data is exported in a CoreML-compatible format and embedded in the .aiMovie file.
   This data enables real-time facial mapping and avatar replacement on devices like Apple TV.
6 Playback Integration
   During playback, the .aiMovie file simultaneously reads:
      The original movie content,
      CoreML facial tracking metadata,
      User avatars (adult or child, depending on context).
   The system executes real-time avatar superimposition, maintaining original cinematic fidelity and synchronizing expressions, gestures, and lip movements with the original actor.

### Technical Implementation

Software Stack:
   Jupyter Notebook: Used for interactive movie playback and bounding box annotation.
   Python: Executes AI model training, facial tracking data extraction, and CoreML preparation.
   C #API: Handles secure storage of bounding box coordinates and user-selected images.
Proprietary Features:
   .aiMovie format contains both unaltered movie content and synchronized facial metadata.
   CoreML compatibility ensures seamless integration with Apple devices.
   Real-time rendering preserves original content while enabling personalized avatars.

### Novelty and Non-Obviousness

1 Integrated Real-Time Pipeline: No known system combines original movie storage, CoreML facial tracking metadata, and user avatar superimposition for real-time playback across consumer devices.
2 User-Driven Annotation and Selection: The combination of Jupyter Notebook interactive annotation with backend storage and AI training is unique and proprietary.
3 Cross-Device Compatibility: Embedding both original content and training data in .aiMovie allows playback and personalization on Apple TV using standard CoreML frameworks.
4 Security and Validation: Combined with blockchain and Zero-Knowledge Proofs, the .aiMovie format ensures content authenticity and prevents unauthorized manipulation.

This proprietary workflow and file format underpin the personalized and autonomous media system described in the main patent, enabling scalable, secure, and immersive experiences while preserving original cinematic content and user control.

### Addendum: Application to Audio Media

It is understood that the systems, methods, modules, and processes described in the present patent, while primarily illustrated with visual media, are equally applicable to audio-only media, including songs, musical performances, spoken word, or other vocal content (hereinafter “.AIMusic”).

Personalized avatar integration, real-time mapping, AI-driven autonomous generation, biometric authentication, and secure blockchain/zero-knowledge proof validation described herein can be applied to user vocal avatars, enabling real-time substitution, augmentation, or integration of a user's voice into original audio content.

The proprietary .AIMovie file format and all methods of preserving original content integrity, mapping avatars, and synchronizing expressive features extend seamlessly to audio media using the .AIMusic format, without modification of the underlying invention.

This addendum clarifies that the patent's teachings are media-agnostic, covering both visual and audio embodiments, while maintaining all original claims, security, and AI-driven workflows.

1. A system for personalized and AI-generated media content, comprising:
a user input interface configured to receive avatar data or user prompts;
a personalized avatar integration module operable to map one or more user avatars onto pre-recorded media contained in a .AIMovie file in real time;
an AI-driven autonomous movie generation engine configured to dynamically generate characters, scenes, and narratives based on user input;
a biometric verification module (FaceID) for authenticating user identity and parental authorization when required;
a secure storage module configured to encrypt and store avatars and AI-generated content using blockchain and zero-knowledge proof validation;
and a playback interface configured to deliver personalized or AI-generated content to a display device.

2. The system of claim 1, wherein the personalized avatar integration module replaces actors' faces with user avatars in real time, synchronizing facial expressions, lip movements, and gestures.

3. The system of claim 1, wherein the AI-driven autonomous movie generation engine creates open-ended narratives without relying on pre-recorded actors or fixed scripts.

4. The system of claim 1, wherein child avatars are playable only under parent or guardian supervision, and parental biometric verification is required prior to playback.

5. The system of claim 1, wherein avatars and AI-generated content are stored within the proprietary .AIMovie file format, preserving original media content without modification.

6. The system of claim 1, wherein blockchain technology stores tamper-resistant records of content access and authorization.

7. The system of claim 1, wherein zero-knowledge proofs validate user and parental authorization without exposing biometric or avatar data.

8. The system of claim 1, wherein the playback interface disables avatar rendering or AI-generated content if biometric verification fails or if access authorization is invalid.

9. The system of claim 1, wherein the AI-driven autonomous movie generation engine enforces ethical content safeguards to prevent harmful or illegal material while maintaining creative freedom.

10. A method for generating personalized and AI-driven media content, comprising the steps of:
receiving avatar data or user prompts;
authenticating user identity and parental authorization via FaceID biometric verification;
integrating user avatars into pre-recorded media in real time using the .AIMovie file format;
generating autonomous media content using an AI narrative engine with virtual character and scene creation;
storing avatars and AI-generated content securely using encryption, blockchain, and zero-knowledge proof validation;
delivering personalized or AI-generated content to a playback device;
and enforcing ethical safeguards during content creation.

11. The method of claim 10, wherein child avatars are playable only after parental authorization is validated using biometric verification.

12. The method of claim 10, wherein the AI-generated content evolves continuously based on user prompts or interactions.

13. The method of claim 10, wherein multiple users may collaboratively input prompts to co-author an AI-generated media experience in real time.

14. The system or method of claims 1-13, wherein the media content is compatible with virtual reality, augmented reality, and interactive gaming platforms.

15. The system or method of claims 1-14, wherein the original media content stored in the .AIMovie file is not altered by avatar replacement or AI content generation.
